(19) United States
(12) Patent Application Publication
(10) Pub. No.: US 2005/0239034 A1
(43) Pub. Date: Oct. 27, 2005

(54) Client/server distribution of learning content

(76) Inventors: Francis McKeagney, County Dublin (IE); Robert Brady, County Kildare (IE); Claudio Perrone, County Dublin (IE); David Meaney, Dublin (IE); Seamus Brady, Dublin (IE); Dermot Reid, Dublin (IE)

Correspondence Address: JACOBSON HOLMAN PLLC, 400 SEVENTH STREET N.W., SUITE 600, WASHINGTON, DC, 20004, US

(21) Appl. No.: 11/100,561

(22) Filed: Apr. 7, 2005

Related U.S. Application Data
(60) Provisional application No. 60/559,969, filed on Apr. 7, 2004.

(51) Int. Cl. G06F 12/00

(52) U.S. Cl. 434/350

(57) ABSTRACT

A platform (1) comprises a client device interface (5) is for communication with devices operated by students, in this case software students. The client device interface (5) comprises an XML web server (6) for method calls from client devices (7). The platform (1) also comprises a content interface (10) which is linked with a content database (11). Between the interfaces the platform (1) comprises a distribution mechanism (25) having a real time clock for controlling distribution of content to client devices (7). A decision mechanism (30) automatically controls access to content, and a synchronization controller (32) manages a group of platform synchronization tables (33). There is no need to download content every time a particular client device (7) accesses the platform (1), as automatic synchronization of the tables at the platform and client ends ensure full access control to content remaining on the client device (7). If a student requests access to content using a different client device there is again synchronization and access can continue as if the same device is used, after the content is downloaded and decrypted.

### INTRODUCTION

1. Field of the Invention

The invention relates to computer based training wit client/server communication.

2. Prior Art Discussion

At present, distribution of content to students typically involves a learning management system allowing a client device to access content on a server and the client device executing a player program while communicating with the server.

However, much learning content is rich in media and therefore a high bandwidth is required, as is continuity of the link to the server.

The invention is directed towards providing a more versatile mechanism whereby the link with the server is not required at all times, and/or a variety of different client devices may be used, and/or there is improved security.

### SUMMARY OF THE INVENTION

According to the invention, there is provided a computer based learning system comprising:
a plurality of student client devices each executing an interface program for transmitting learning content requests and for receiving downloaded content, and a player program for playing received learning content; and
a platform comprising:
   a client device interface for interfacing with the client devices to receive content requests and to download content to the client devices,
   a content interface for accessing the learning content,
   a distribution mechanism for receiving the client device requests via the client device interface, and for downloading content and an activation key via the client device interface in response to each request if the request is allowed, said activation key being operable on the client device to activate the content,
   a decision mechanism for deciding on content access in response to the requests according to access control criteria, and
   a synchronization controller for maintaining synchronization records of client device content usage and for automatically updating different client device to ensure synchronized tracking of content usage across a plurality of said client devices for each student.

In one embodiment, the distribution mechanism validates a content request from a client device according to verification of a student identifier and client device data embedded in the client device interface program, and included automatically by the client device in the uploaded request.

In one embodiment, the distribution mechanism encrypts the content before it is downloaded.

In another embodiment, the distribution mechanism encrypts the content using a symmetric key, and the interface program of each client device has a corresponding symmetric key embedded within its code for decrypting and installing downloaded content.

In one embodiment, the interface program of each client device is obfuscated.

In one embodiment, the activation key allows access by the client device through a containment hierarchy of the content to a binary level of content data and instructions.

In another embodiment, the distribution mechanism automatically sets the low-level data and instructions which require activation using the activation key.

In a further embodiment, the distribution mechanism automatically sets said data and instructions according to a stored profile of a student operating the client device.

In one embodiment, each client device verifies the received activation key by independently generating a key locally and comparing it with the received key.

In one embodiment, the key is generated locally using a hashing mechanism operating on student identifiers.

In one embodiment, the hashing mechanism operates on an association of identifiers of the student and of content to be activated.

In one embodiment, the distribution mechanism transmits the activation key via a different delivery channel from that used for download of content, and the client device interface program only verifies the activation key if it receives the key in an interactive input made by the student.

In one embodiment, the distribution mechanism encrypts the activation key and the client device interface program decrypts the activation key using the same key used to decrypt the content.

In one embodiment, the synchronization controller maintains a platform synchronization table upon download of an activation key, and populates the table with content and student identifiers and activation data, and the client device interface program automatically maintains a client synchronization table with data mirroring that of the platform synchronization table.

In one embodiment, the synchronization controller generates a fresh table for each unique association of a student identifier with a content identifier.

In a further embodiment, each client device automatically establishes a session with the platform upon a student input for playing of content, and the platform and the client device synchronize their tables upon links being established.

In one embodiment, the synchronization controller automatically determines from the decision mechanism an activation time period and writes this period to the synchronization table, and the client device interface program uses the received activation period to update the client synchronization table.

In one embodiment, the client device interface program stores a received activation key until a request for activation of content is received at a later time.

In one embodiment, the client device interface program automatically updates its synchronization table by comparing real time with the expiry time and writes a expired status to the table if the real time is later than an expiry time table value.

In another aspect, the invention provides a method of operation of a computer based learning platform and a student client device, the method comprising the steps of:
the student client device executing an interface program to transmit a learning content request to the platform,
a client device interface of the platform interfacing with the client devices to receive the content request,
a distribution mechanism of the platform receiving the client device request via the client device interface,
a decision mechanism of the platform deciding on content access in response to the request according to access control criteria,
the distribution mechanism downloading the content and an activation key via the client device interface in response to the request if the request is allowed by the decision mechanism,
the client device using the activation key to activate the content, and a player program of the client device playing the content, and
a synchronization controller of the platform maintaining synchronization records of client device content usage and automatically updating different client devices to ensure synchronized tracking of usage of the content across a plurality of different client devices for the student.

### Detailed Description of the Invention

### BRIEF DESCRIPTION OF THE DRAWINGS

The invention will be more clearly understood from the following description of some embodiments thereof, given by way of example only with reference to the accompanying drawings in which:

FIG. 1 is a block diagram of a content access control platform of the invention;

FIG. 2 is a flow diagram illustrating operation of the platform and of a client device communicating with it;

FIG. 3 is a high level flow diagram showing major signal flows between the platform and client devices; and

FIGS. 4 to 6 are flow diagrams illustrating operation of the platform in more detail.

### DESCRIPTION OF THE EMBODIMENTS

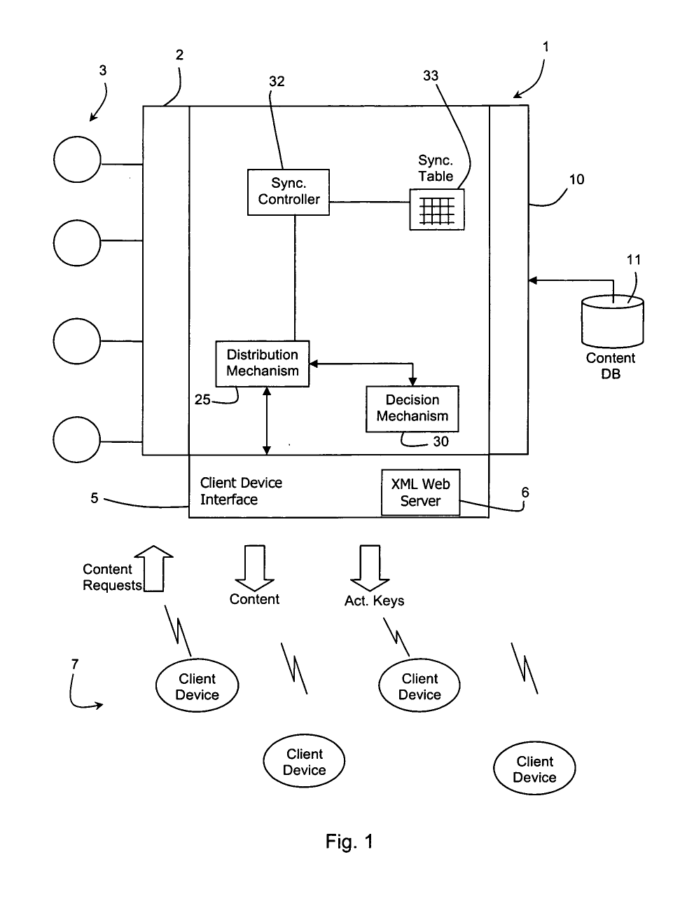

Referring to FIG. 1 a server or platform 1 comprises an administrator interface 2 for communication with administrator systems 3. A client device interface 5 is for communication with devices operated by students, in this case software students. The client device interface 5 comprises an XML web server 6 for method calls from client devices 7. The platform 1 also comprises a content interface 10 which is linked with a content database 11. The latter in this embodiment is local; however, it may in an alternative embodiment be distributed.

Between these interfaces the platform 1 comprises a distribution mechanism 25 having a real time clock for controlling distribution of content to client devices 7. The platform 1 also comprises:
a decision mechanism 30 for automatically controlling student access to content, and
a synchronization controller 32 which manages a group of platform synchronization tables 33.

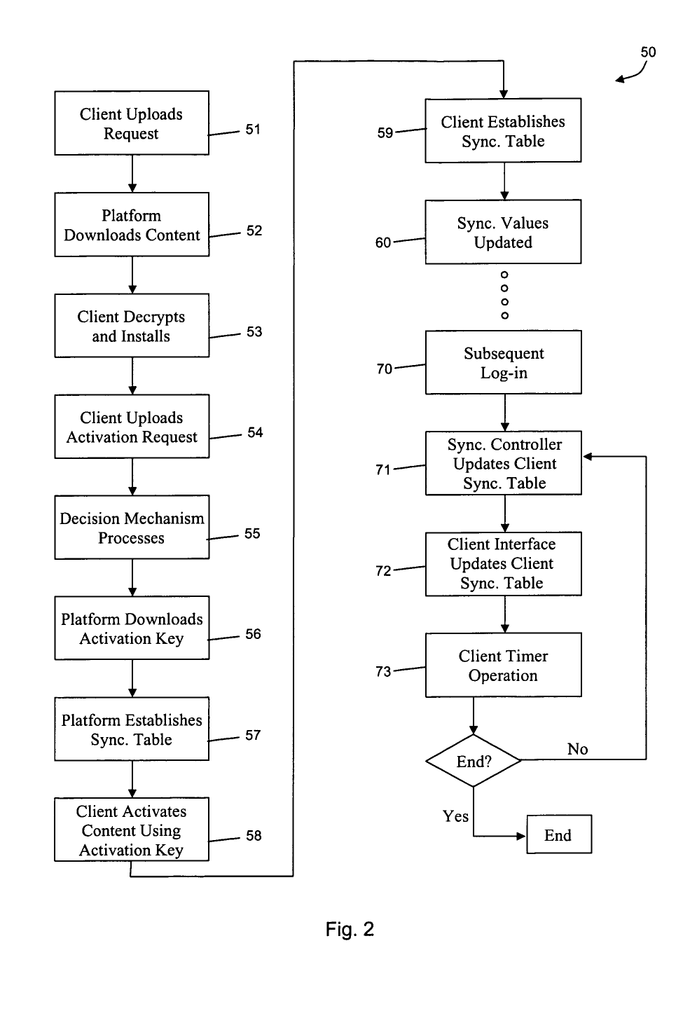

Referring to FIG. 2 operation of the platform 1 and a client device 7 is described as an overall method 50. Each client device 7 has a platform interface which is programmed with access control settings to allow authorised access to the platform. The interface program is obfuscated so that it may not be easily de-compiled. For initial access to the platform the device transmits a username and password provided by the student.

In step 51, upon log-on the student client device uploads a content request with a student identifier which is embedded in the interface program, which request is received by the Web server 6 of the client device interface 5. The distribution mechanism 25 validates that the request is from a valid client device/student combination by verifying the student identifier and device data embedded by the device 7 in the uploaded request.

In step 52 the distribution mechanism 25 accesses the relevant content in the database 11 via the content interface 10, and downloads it, encrypted, to the requesting client device 7. The encryption is performed using a symmetric encryption key.

In step 53 the client device 7 then uses a symmetric decryption key embedded in the interface program to decrypt the content. It then installs the content. However, the content can not be used as it is not activated. It is in the form of binary data and instructions at the leaf nodes of a containment hierarchy, the upper levels of which prevent access without an activation key.

In step 54 the client device 7 uploads an activation request to the platform 1 and in step 55 the decision mechanism 30 executes to automatically decide on the level of access to be allowed according to access control criteria. The decision mechanism 30 operates in a manner which is independent of the distribution mechanism 25 to the extent that the operation of downloading the content is decoupled from that of controlling the extent of access to it.

If access is to be allowed, the distribution manager 25 downloads an activation key in step 56 via a different route, in this case by email. The activation key includes embedded information associating the student with the relevant content.

In step 57 the controller 32 establishes a synchronization table (within the group of tables 33) for the content/student association. There is one table for each unique content/student association. The synchronization table includes initial values including identifiers for the content and student and current time and date. There is a unique dataset associating the specific content for which access is being allowed and the particular student, and this is stored in the synchronization table 33. Also, the output of the decision mechanism 30 is also stored as an expiry period value in a cell of the synchronization table for student access to the content.

Upon receipt of the activation key, in step 58 the client device 7 activates the content using the key, allowing a player program to have access to all levels through the containment hierarchy to binary data and instructions at lower levels in the hierarchy.

The activation key received from the platform 1 may be held in the client device 7 for a period of time until the student is ready to activate the content. Before activating the content the client device 7 interface program first requests the student to input an identifier. It then uses this identifier and a content identifier to execute a hashing mechanism to locally generate the key independently of what has been received from the platform 1. It then compares the locally-generated key with that received from the platform (via a separate delivery channel). It is only if they match that the interface program of the client device 7 uses the key to activate the content. Also, this program will only have access to the platform-generated key if it has been manually “cut and pasted” into its GUI from the messaging application which received it from the platform.

A further level of security is provided by the fact that the platform-generated key is encrypted using the symmetric key used to encrypt the content. The interface program can not operate to compare the locally and platform-generated keys unless it can successfully decrypt the one generated by the platform 1.

The client device 7 then in step 59 establishes a client synchronization table and updates it in step 60 with values including:
real time activation time and date,
an expiry time and date calculated from the activation time and date and the use period outputted by the decision mechanism 30,
a content identifier,
a student identifier, and
a value indicating activated status of the content.

The other possible status values are “deactivated” and “expired”.

Upon establishing the client synchronization table, the interface program automatically transmits an update to the distribution mechanism 25 of the platform 1 to indicate the change of status, upon which the synchronization controller 32 makes a corresponding update to the table 33.

The client device 7 player program then executes the learning content according to the student instructions. As this happens, the synchronization controller 32 receives frequent updates concerning operation of the device 7 and automatically updates the table 33, and the client table is also automatically updated by the client interface program.

As indicated by steps 70 to 73 at a subsequent operation by the client device 7 of the content the interface program of the device 7 automatically logs on to the platform 1 as described above and the platform synchronization controller 32 ensures that the table 33 is updated in step 71 and the interface program on the client in step 72 ensures that the local table is synchronized as long as the content is executed by the player.

An advantageous aspect is that if the student uses a different client device 7 for a subsequent learning session, that device will log on as described above provided it executes a valid copy of the interface program. That interface program automatically requests, receives, and activates the content largely as described above for steps 51 to 52. This client device 7 has a fresh client synchronization table which is automatically updated with the contents of the platform table 33. Also, the table on the client is encrypted. One difference in the process in this case is that the activation key is not downloaded by email. Instead, the distribution mechanism 25 downloads the student/content association from the platform synchronization table 33 and the content status for the client table. The client interface program then synchronizes the client synchronization table with the table 33 and has full access because the content status is “activated”.

Over time, whether using only one or a number of client devices 7 the expiry time of the synchronization tables is reached, as indicated by real time clocks on both the platform 1 and the client devices 7. When this happens, the tables are updated to change the status from “activated” to “expired” and so subsequent requests for access to content must go through the method of steps 51 to 60. Failing this the player executing on the client device 7 will not have access through the upper containment levels of the content hierarchy because the synchronization table does not indicate that the status is “activated”.

When the content is deactivated the player program on the client device 7 is allowed to navigate through the upper containment layers of the content hierarchy to view menus of content which he or she may wish to activate in the future. This is because the deactivation only affects the lower binary data and instruction levels, preventing execution of specific learning functions. The de-activated learning functions are not the subject of the invention, however, they are customizable by the distribution mechanism 25 setting the functions which are to be de-activated when downloading the content initially to the client device. This is in response to the stored profile of the student or the student group/organization to which he or she belongs.

If the status in the platform synchronization table is “expired” in a subsequent content request, then the distribution mechanism 25 will not download the content if the request is for access to learning/content functions in content already downloaded. Instead, it simply updates the platform table 33 according to the activation period allowed by the decision mechanism and the client device table is automatically synchronized, thus allowing future player access.

Thus, the output of the decision mechanism 30 is implemented on an ongoing basis irrespective of the client device being used or indeed its geographic location.

Decision Mechanism 30 Operation

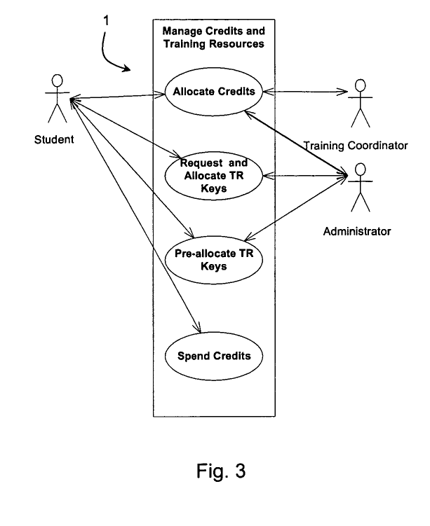

Referring to FIG. 3 the decision mechanism 30 allocates content access or training credits. The student requests training (TR) keys and spends TR credits. A student administrator (DA) 3 interacts with the platform 1 to allocate TR keys (within the confines of an overall pool), pre-allocates TR keys, and allocates credits. A coordinator uses the platform 1 to set a pool of content credits and to divide up the pool among the administrators. Students use the platform to access content according to the allocated credits.

In more detail, a student installs binary content (also known as Practice Sets) downloaded from the platform 1 as described above. He or she requests activation of a Practice Set or extension for a Practice Set that has previously been activated but has since gone into a “expired” mode. The decision mechanism 30 manages requests and determines whether the organisation to which the student belongs has a Paid or Open contract mode.

If a contract mode is “Paid”, the mechanism 30 determines which user account to debit. If there are sufficient credits, the mechanism 30 debits the credits in the account by the cost of the Practice Set, as configured in a catalogue of the mechanism 30. The following steps are also performed:
the synchronization controller 32 starts a timer (default of 90 days) on this student/Practice Set combination,
the distribution mechanism 25 assigns a Personal Tutor, and
the client device interface sends e-mail notification to the Personal Tutor of the new assignment.

If there are insufficient credits, the decision mechanism 30 creates a new activation/extension request and sends an e-mail alert to an administrator system 3 for this student.

The decision mechanism 30 can decide whether to allow all administrators 3 to access any credits held by the organisation (Pooled Credit mode), or to allocate credits strictly on an individual administrator basis (A Credit mode). This setting can be modified at any time. In Pooled Credit mode, all of the credits owned by an organisation can be used by any of the coordinators, in “first come first served” order. When the setting is set to A Credit mode, each administrator system 3 has access to an individual credit count, which they can spend on Practice Set activation and extension as they wish.

A coordinator is responsible for managing administrators and allocating credits to them in the mechanism 30. For each client organisation there is exactly one coordinator. An administrator system 3 is responsible for managing students (registering, deleting, grouping) within an organisation. The administrator is the single Actor within the system who can assign the role “student” to a user that they have created, and has ability to view activity reports for students that they control (in Restricted Mode Student Management) and all students within an organisation (in Relaxed Mode Student Management).

The Support Contract mode of an organisation can be Paid or Open. Open SC means effectively that all students have full access to all Practice Sets for the duration of the contract. Paid SC means that a finite number of credits are held by the client organisation and the credits are allocated and spent according to rules.

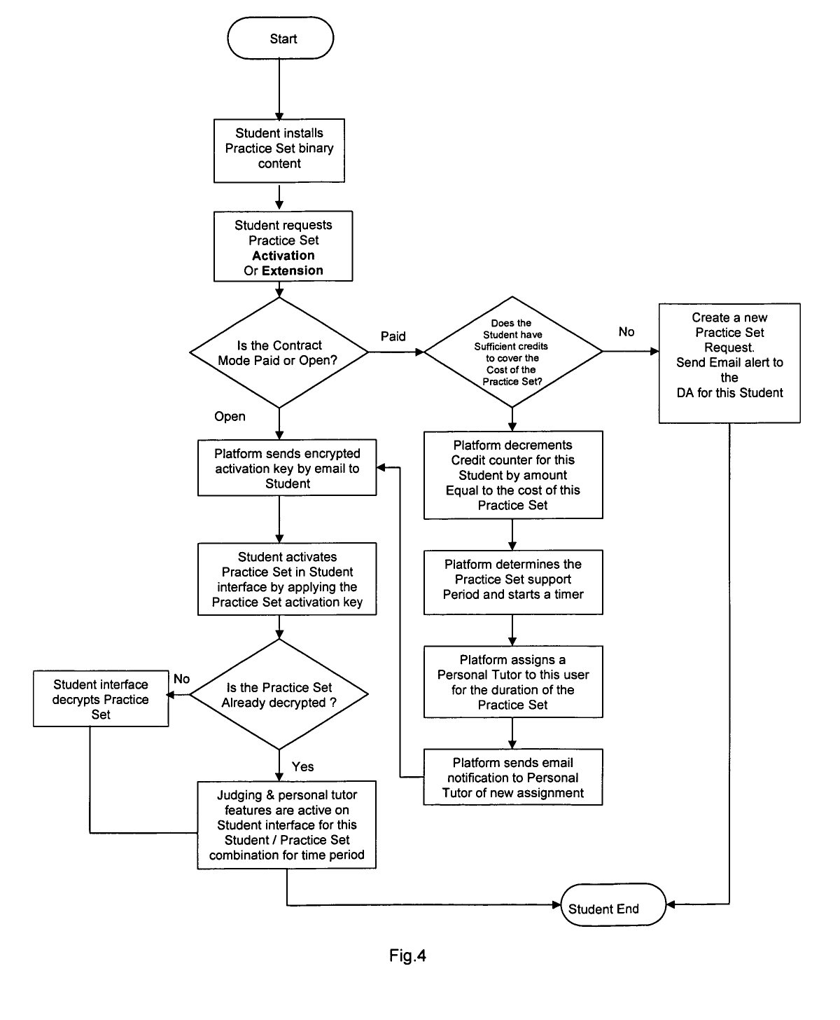

Referring to FIG. 4 a flow diagram for student request activation is shown. Practice Set binary content is installed on their client device by a student. When a student requests Practice Set Activation or Extension, the decision mechanism 30 decides whether the contract Mode is Paid or Open. If Open, the decision mechanism 30 instructs the distribution mechanism 25 to transmit an encrypted activation key by e-mail to the relevant client device 7. The client device 7 then activates the PS. The device 7 has access to the content for a time period which expires with the expiry date in the synchronization tables.

As shown by the Paid branch of the diagram, if the mode is Paid, the synchronization controller 32 determines whether the student has sufficient credits to cover the cost of the PS. If there is insufficient credit, it creates an alert and transmits it to an administrator system 3 for the student. If there is sufficient credit, the controller 32 decrements in the table 33 the credits available for that student by the cost of the PS. It then determines the support period and activates a timer. A Personal Tutor is then assigned to this student for the duration of the PS as follows: The controller 32 keeps a record of each student/Personal Tutor assignment and assigns the current student, the Personal Tutor who currently has the least number of students assigned to them. If more than one Personal Tutor has the same number of students assigned to them, then one is picked at random.

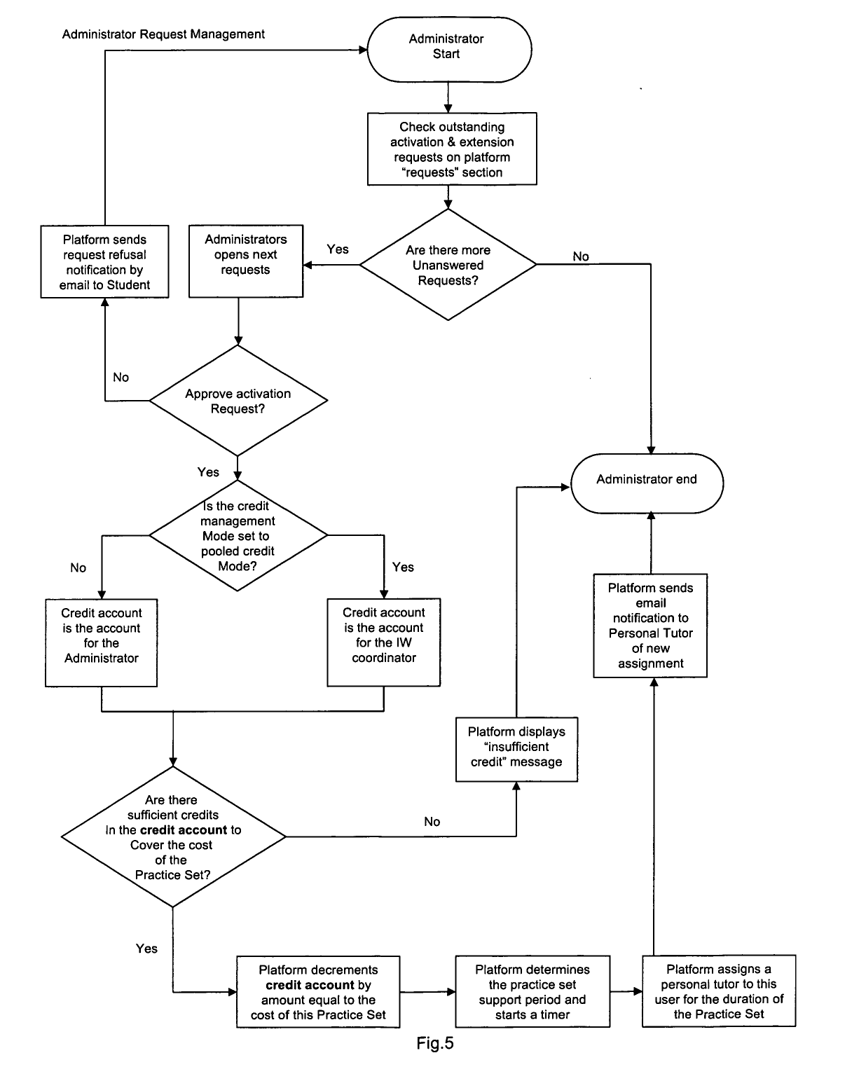

Referring to FIG. 5 operation of an administrator system 3 is now described in more detail. Upon activation, it checks for outstanding student requests and opens any which exist. If it does not approve the request, it sends a refusal notification to the relevant student device 7. If it is approved, the system 3 checks if the mode is Pooled or Credit. If Pooled, the account is that of the co-ordinator, and if not, it is the account of the administrator. The administrator system 3 then checks if there is sufficient credit, and if not, it transmits a message to the client device 7. If there is sufficient credit, the administrator system 3 instructs the decision mechanism 30 to decrement the credit by the relevant amount, and the controller 32 then determines the relevant PS support period and starts a timer. The platform 1 keeps a record of each student/Personal Tutor assignment and assigns the current student for the period, the Personal Tutor in the system who currently has the least number of students assigned to them. If more than one Personal Tutor has the same number of students assigned to them, then one is picked at random.

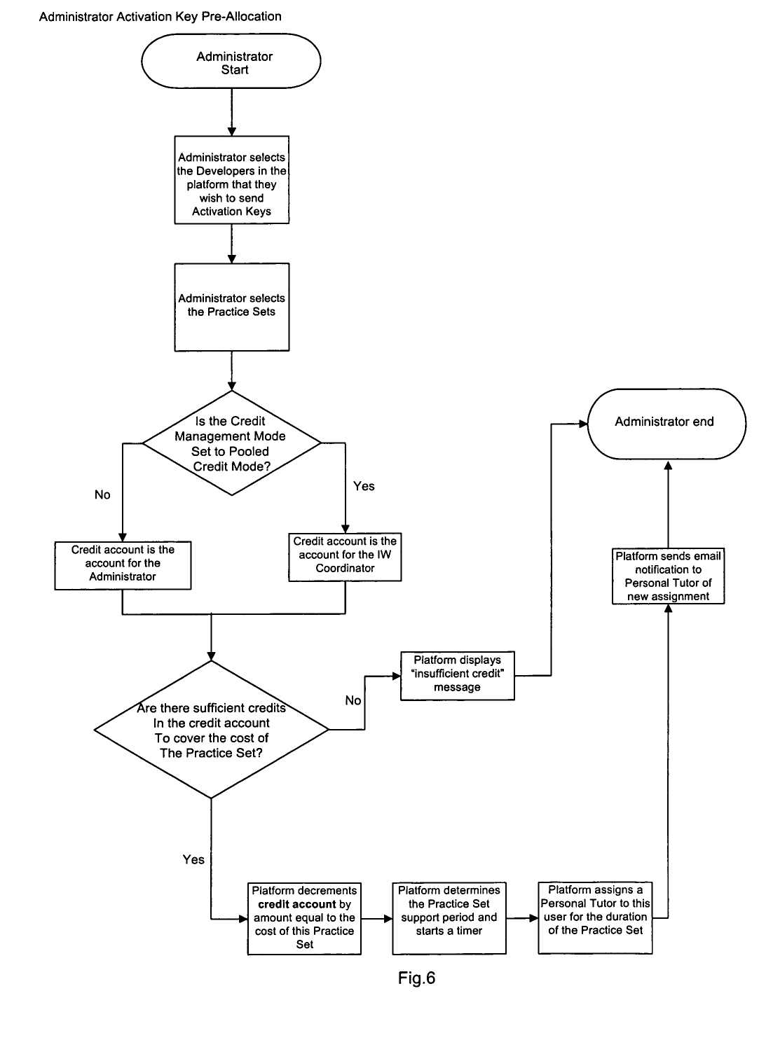

The process for transmitting activation keys is shown in FIG. 6. The relevant student devices 7 and PSs are chosen and the credit mode is selected. Again, if Pooled, the account is that of the coordinator, and if not it is that of the administrator 3. If there is insufficient credit, an appropriate message is displayed. If there is sufficient credit, the mechanism 25 instructs the controller 32 to decrement the credit amount, the period is determined, and a timer is set. Again, a Personal Tutor is assigned.

Use Cases

| Use Case Name | Pre-allocate TR Activation Key |
|---|---|
| Iteration | Filled |
| Summary | A TA allocates Activation Key(s) to a Student for a specific |
| | Training Resource. The TR Activation key is sent to the |
| | Student, along with an alert message. |
| Basic Course of Events | 1. The TA selects the option to pre-allocate the Activation |
| | Key(s). |
| | 2. The System responds with a list of Practice Sets that exist |
| | in the current catalog. |
| | 3. The TA selects the Practice Set or Sets that for which he |
| | wants to allocate a key. |
| | 4. The system prompts the TA for confirmation that they |
| | wish to proceed with the allocation. |
| | 5. The TA proceeds. |
| | 6. Depending on the Credit Allocation Mode for the |
| | organization, either the global credit count or the credit |
| | count for that TA is reduced by the combined cost of the |
| | Keys allocated. |
| | 7. All of the Students to whom Activation Keys have been |
| | pre-allocated receive an e-mail notification and the |
| | Activation Key, by e-mail also. |
| | 8. The system informs the Student Administrator that the TR |
| | Activation Key Allocation is complete. |
| Alternative Paths | |
| Exception Paths | At step 6, if the total cost in credits exceeds the available |
| | credits for that TA, the allocation attempt is aborted by the |
| | system, and a message is displayed to the user. The total |
| | credit cost is the number of Students * the credit cost of the |
| | practice set selected. No attempt is made by the system to |
| | partially complete the allocation if the credit balance is |
| | insufficient. |
| Extension Points | |
| Trigger | |
| Assumptions | |
| Preconditions | “Manage Students” is open is “Student View” |
| Postconditions | Depending on the Credit Allocation Mode for the |
| | organization, either the global credit count or the credit count |
| | for that TA is reduced by the combined cost of the Keys |
| | allocated. |
| | All of the Students to whom Activation Keys have been pre- |
| | allocated receive an e-mail notification and the Activation |
| | Key, by e-mail also. |
| Related Business Rules | |
| Date | Facade 25/07/03; Filled 28/07/03 |
| Actors | Student Administrator |

| Use Case Name | Request TR Activation |
|---|---|
| Iteration | Filled |
| Summary | A Student requests Activation for a specific Training |
| | Resource |
| Basic Course of Events | 1. The Student starts by browsing the catalog |
| | 2. The system responds with the list of practice sets in the |
| | catalog. |
| | 3. The Student selects a Practice set. |
| | 4. The Student selects the option “Request Activation |
| | Code”. |
| | 5. The system responds by prompting for confirmation. |
| | 6. The Student proceeds. |
| Alternative Paths | |
| Exception Paths | |
| Extension Points | |
| Trigger | The Student wishes to get access to a Practice Set. |
| Assumptions | |
| Preconditions | |
| Postconditions | When the TR Activation Request is raised, the system checks |
| | the credit cost of the Practice Set requested against the |
| | credits available to that Student. If there are sufficient credits |
| | against that Student, the following occurs: |
| | The credit cost of the Practice Set is deducted from the |
| | credit count of the Student. |
| | The Activation Key is sent to the Student. |
| | If the credit amount for the Student is insufficient, the system |
| | puts the TR Activation Request in the in tray of the Student |
| | Administrator for that Student. |
| Related Business Rules | |
| Date | Facade 25/07/03; Filled 28/07/03 |
| Actors | Student |

| Use Case Name | Approve TR Request |
|---|---|
| Iteration | Facade |
| Summary | A TA selects an outstanding TR Activation Key Request and |
| | chooses to approve the request. |
| Basic Course of Events | 1. The Student Administrator selects an Activation Key |
| | Request which has the status “outstanding”. |
| | 2. The Student Administrator chooses to grant the Activation |
| | Key Request. |
| | 3. The system informs the TA that the request has been |
| | granted. |
| Alternative Paths | |
| Exception Paths | In step 2, the credit cost of the practice set in the request |
| | exceeds the credits available to the TA. The system raises an |
| | error. |
| Extension Points | |
| Trigger | |
| Assumptions | |
| Preconditions | There are outstanding requests from the TAs Default Group |
| | Students. |
| Postconditions | Credits equal to the Credit cost of the Practice Set in the |
| | Request are deducted from the credit count of the TA (for |
| | TA Credit Mode) or the Organization (for Pooled Credit |
| | Mode) |
| | The system changes the status of the TR Activation |
| | Request to “Granted”. |
| | An e-mail containing the activation key is sent to the |
| | Student from whom the request originated. |
| Related Business Rules | |
| Date | Facade 25/07/03; Filled 28/07/03 |
| Actors | Student Administrator |

| Use Case Name | Refuse TR Request |
|---|---|
| Iteration | Facade |
| Summary | A TA selects an outstanding TR Activation Request and |
| | chooses to refuse the request. |
| Basic Course of Events | 1. The Student Administrator selects an Activation Key |
| | Request which has the status “outstanding” |
| | 2. The Student Administrator chooses to refuse the |
| | Activation Request. |
| | 3. The system prompts the TA to confirm that they wish to |
| | refuse this TR Activation. |
| | 4. The TA then chooses to proceed or cancel. |
| Alternative Paths | |
| Exception Paths | |
| Extension Points | |
| Trigger | |
| Assumptions | |
| Preconditions | |
| Postconditions | The system changes the status of the TR Activation Request |
| | to “Refused”. The system sends notification by e-mail of the |
| | refusal to the Student. |
| Related Business Rules | |
| Date | Facade 25/07/03; Filled 28/07/03 |
| Actors | Student Administrator |

It will be appreciated that the invention provides a system and method for efficient and dynamic management of access to content. It is particularly advantageous where there are many students and many sets of content and access criteria.

The invention is not limited to the embodiments described but may be varied in construction and detail.

1. A computer based learning system comprising:
a plurality of student client devices each executing an interface program for transmitting learning content requests and for receiving downloaded content, and a player program for playing received learning content; and
a platform comprising:
a client device interface for interfacing with the client devices to receive content requests and to download content to the client devices,
a content interface for accessing the learning content,
a distribution mechanism for receiving the client device requests via the client device interface, and for downloading content and an activation key via the client device interface in response to each request if the request is allowed, said activation key being operable on the client device to activate the content,
a decision mechanism for deciding on content access in response to the requests according to access control criteria, and
a synchronization controller for maintaining synchronization records of client device content usage and for automatically updating different client devices to ensure synchronized tracking of content usage across a plurality of said client devices for each student.

2. A system as claimed in claim 1, wherein the distribution mechanism validates a content request from a client device according to verification of a student identifier and client device data embedded in the client device interface program, and included automatically by the client device in the uploaded request.

3. A system as claimed in claim 1, wherein the distribution mechanism encrypts the content before it is downloaded.

4. A system as claimed in claim 1, wherein the distribution mechanism encrypts the content before it is downloaded; and wherein the distribution mechanism encrypts the content using a symmetric key, and the interface program of each client device has a corresponding symmetric key embedded within its code for decrypting and installing downloaded content.

5. A system as claimed in claim 1, wherein the interface program of each client device is obfuscated.

6. A system as claimed in claim 1, wherein the activation key allows access by the client device through a containment hierarchy of the content to a binary level of content data and instructions.

7. A system as claimed in claim 1, wherein the activation key allows access by the client device through a containment hierarchy of the content to a binary level of content data and instructions; and wherein the distribution mechanism automatically sets the low-level data and instructions which require activation using the activation key.

8. A system as claimed in claim 7, wherein the distribution mechanism automatically sets said data and instructions according to a stored profile of a student operating the client device.

9. A system as claimed in claim 1, wherein each client device verifies the received activation key by independently generating a key locally and comparing it with the received key.

10. A system as claimed in claim 1, wherein each client device verifies the received activation key by independently generating a key locally and comparing it with the received key; and wherein the key is generated locally using a hashing mechanism operating on student identifiers.

11. A system as claimed in claim 10, wherein the hashing mechanism operates on an association of identifiers of the student and of content to be activated.

12. A system as claimed in claim 1, wherein the distribution mechanism transmits the activation key via a different delivery channel from that used for download of content, and the client device interface program only verifies the activation key if it receives the key in an interactive input made by the student.

13. A system as claimed in claim 1, wherein the distribution mechanism encrypts the content before it is downloaded; and wherein the distribution mechanism encrypts the activation key and the client device interface program decrypts the activation key using the same key used to decrypt the content.

14. A system as claimed in claim 1, wherein the synchronization controller maintains a platform synchronization table upon download of an activation key, and populates the table with content and student identifiers and activation data, and the client device interface program automatically maintains a client synchronization table with data mirroring that of the platform synchronization table.

15. A system as claimed in claim 14, wherein the synchronization controller generates a fresh table for each unique association of a student identifier with a content identifier.

16. A system as claimed in claim 14, wherein each client device automatically establishes a session with the platform upon a student input for playing of content, and the platform and the client device synchronize their tables upon links being established.

17. A system as claimed in claim 14, wherein the synchronization controller automatically determines from the decision mechanism an activation time period and writes this period to the synchronization table, and the client device interface program uses the received activation period to update the client synchronization table.

18. A system as claimed in claim 1, wherein the client device interface program stores a received activation key until a request for activation of content is received at a later time.

19. A system as claimed in claim 14, wherein the client device interface program automatically updates its synchronization table by comparing real time with the expiry time and writes a expired status to the table if the real time is later than an expiry time table value.

20. A method of operation of a computer based learning platform and a student client device, the method comprising the steps of:
the student client device executing an interface program to transmit a learning content request to the platform,
a client device interface of the platform interfacing with the client devices to receive the content request,
a distribution mechanism of the platform receiving the client device request via the client device interface,
a decision mechanism of the platform deciding on content access in response to the request according to access control criteria,
the distribution mechanism downloading the content and an activation key via the client device interface in response to the request if the request is allowed by the decision mechanism,
the client device using the activation key to activate the content, and a player program of the client device playing the content, and
a synchronization controller of the platform maintaining synchronization records of client device content usage and automatically updating different client devices to ensure synchronized tracking of usage of the content across a plurality of different client devices for the student.

21. A computer program product comprising software code for performing platform operations of a method of claim 20 when executing on a digital processor.

22. A computer program product comprising software code for performing client device operations of a method of claim 20 when executing on a digital processor.
